(19) United States
(12) Patent Application Publication
(10) Pub. No.: US 2009/0132211 A1
(43) Pub. Date: May 21, 2009

(54) AUTOMATED SOLUTION FOR GENERATING ARCHITECTURAL DESIGN MODELS FOR SERVICE-ORIENTED ARCHITECTURE (SOA) INFORMATION SERVICES

(75) Inventors: EOIN LANE, LITTLETON, MA (US); BERTRAND H. PORTIER, KESWICK (CA)

Correspondence Address: PATENTS ON DEMAND - Lockheed Martin, 4581 WESTON ROAD , SUITE 345, WESTON, FL, 33331, US

(73) Assignee: INTERNATIONAL BUSINESS MACHINES CORPORATION, ARMONK, NY (US)

(21) Appl. No.: 11/942,191

(22) Filed: Nov. 19, 2007

(51) Int. Cl. G06F 17/10

(52) U.S. Cl. 703/2

(57) ABSTRACT

The present invention discloses a system that automates the creation of architectural design models for information services. Such a system can include a data model written in a formal modeling language, a set of non-functional requirements about the information service, and an information service architecture generation tool. The information service architecture generation tool can be configured to utilize the data model, the set of non-functional requirements, and application patterns to create an architectural design model for the information service. The information service can be implemented in a service-oriented architecture (SOA) environment.

### BACKGROUND

1. Field of the Invention

The present invention relates to the field of information service architectural design and, more particularly, to an automated solution for generating optimal architectural design models for service-oriented architecture (SOA) information services.

2. Description of the Related Art

The use of service-oriented architecture (SOA) environments and information services is fast becoming the preferred implementation for enterprise systems. A popular method for creating the architectural design models used to implement information services is the use of application patterns. An application pattern represents a repeatable solution to a problem in a particular context. For example, the preferred data source pattern is applicable when an information service requires data consistency.

As businesses expand their enterprise capabilities, new information services need to be added to accommodate the expansion. However, the design and development of information services using application patterns is an error-prone, manual process that relies heavily upon the skill and experience of the designer, known as a solution architect. That is, the quality of resultant architectural design model is directly related to how well the solution architect understands the complex relationships between the application patterns and the non-functional requirements of the information service.

Because the design process is hinged upon a human element, the information services within an enterprise system often lack consistency. These inconsistencies continue to propagate and can eventually degrade the performance of the overall system.

What is needed is a solution that automates the design process for architectural design models. That is, the solution would enable solution architects of varying skill levels to all produce architectural design models of the same quality. Ideally, such a solution would leverage the resources of a commercially-available software development tool that supports SOA application patterns.

### SUMMARY OF THE INVENTION

The present invention discloses an automated solution for generating optimal architectural design models for information services that are to be implemented within a service-oriented architecture (SOA) environment. The automated solution can represent a design tool that can consistently apply trusted SOA patterns to a data model. The tool can utilize the non-functional requirements of the information service to determine which patterns are applicable to the information service and in which order the patterns should be applied in order to produce an optimal architectural design model.

The present invention can be implemented in accordance with numerous aspects consistent with material presented herein. For example, one aspect of the present invention can include a system that automates the creation of architectural design models for information services. Such a system can include a data model written in a formal modeling language, a set of non-functional requirements about the information service, and an information service architecture generation tool. The information service architecture generation tool can be configured to utilize the data model, the set of non-functional requirements, and application patterns to create an architectural design model for the information service. The information service can be implemented in a service-oriented architecture (SOA) environment.

Another aspect of the present invention can include an automated method for generating optimal architectural design models for information services. The method can begin by launching an information service architecture generation tool. A data model describing the information service can be loaded into the generation tool. The generation tool can solicit data about the non-functional requirements of the information service, which can be input into a user interface by a user. Then, the generation tool can automatically synthesize an optimal architectural design model for the information service using a set of known service-oriented architecture (SOA) application patterns. Each application pattern can correspond to a service non-functional requirement of an information service.

Still another aspect of the present invention can include an information service architecture generation tool. The generation tool can include a set of application patterns, a user interface, and a pattern determination engine. Each pattern of the pattern set can correspond to a specific service non-functional requirement of the information service. The user interface can be configured to collect user-input data about the non-functional requirements of the information service. The pattern determination engine can be configured to utilize the user-input data to determine which patterns and in what order the patterns should be applied to the data model to produce an architectural design model for the information service.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, any other recording medium, or can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system for automatically generating optimal architectural design models for information services in accordance with embodiments of the inventive arrangements disclosed herein.

FIG. 2 is a sample data model for an information service in accordance with an embodiment of the inventive arrangements disclosed herein.

FIG. 3 is an example illustrating the influence of non-functional requirements on pattern relevance in accordance with an embodiment of the inventive arrangements disclosed herein.

FIG. 4 is a flow chart of a method for using an automated solution to generate optimal architectural design models for information services in accordance with an embodiment of the inventive arrangements disclosed herein.

### DETAILED DESCRIPTION OF THE INVENTION

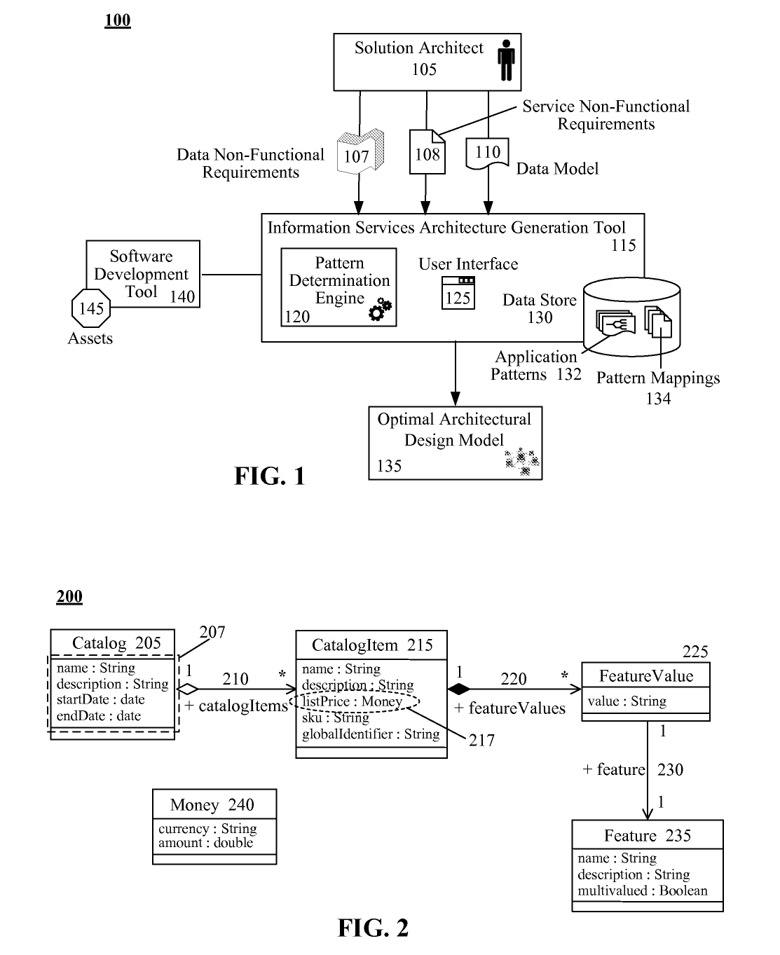

FIG. 1 is a schematic diagram of a system 100 for automatically generating optimal architectural design models 135 for information services in accordance with embodiments of the inventive arrangements disclosed herein. In system 100, a solution architect 105 can input a data model 110 and non-functional requirements 107 and 108 for an information service architecture into an information services architecture generation tool 115, herein referred to as the generation tool, to produce an optimal architectural design model 135.

The generation tool 115 can be a software application that can interface with a commercially-available, model-driven software development tool 140 in order to produce an optimal architectural design model 135 of an information service. By interfacing with the software development tool 140, the generation tool 115 can utilize the assets 145 of the software development tool 140. These assets 145 can encompass a variety of items, such as software functions and data libraries. For example, interfacing with the IBM RATIONAL SOFTWARE ARCHITECT (RSA) tool can provide the generation tool 115 access to RSA's pattern engine and transformation framework.

The generation tool 115 can include a pattern determination engine 120, a user interface 125, and a data store 130 containing a set of SOA application patterns 132 and pattern mappings 134. In another embodiment, the set of SOA application patterns 132 can be included as an asset 145 of the software development tool 140. The set of application patterns 132 can correspond to SOA patterns currently used by solution architects 105 to manually generate architectural design models for information services.

The pattern determination engine 120 can be a software algorithm for generating an optimal architectural design model 135 for an information service. The pattern determination engine 120 can utilize the non-functional requirements 107 and 108 and pattern mappings 134 in order to determine which application patterns 132 are applicable to the information service and the order in which the applicable patterns should be applied to the data model 110.

In order to determine the applicability and application order of the patterns 132, the pattern determination engine 120 can request data from the solution architect 105 via the user interface 125. Requests can be in the form of questions that pertain to the non-functional requirements of the information service 108, and of the data 107. The solution architect 105 can then input answers to these questions into the user interface 125.

The pattern determination engine 120 can utilize a pattern mapping 134 in order to correlate service and data non-functional requirements 107, 108 with specific application patterns 132. The pattern mapping 134 can also include precedence data to assist with determining the pattern 132 order.

Once the applicability and order of the patterns 132 has been established, the pattern determination engine 120 can apply the patterns 132 in the determined ordered to the data model 110. The data model 110 can be a means of visually and/or electronically describing an information service. Further, the data model 110 can be written in a formal modeling language, such as the Unified Modeling Language (UML), supported by the generation tool 115, and/or the software development tool 140.

It is important to note that the format of the data model 110 must be usable by the generation tool 115 and, consequently, the software development tool 140. For example, RSA expects a data model 110 written in UML and would be unable to effectively process a data model 110 written in the Service Modeling Language (SML).

The optimal architectural design model 135 can represent the best architectural design for the information service, based on the data model 110 and non-functional requirements 107 and 108. The architectural design model 135 can be expressed in a formal modeling language supported by the generation tool 115. The architectural design model 135 can also be utilized by the software development tool 140 for additional processing.

The optimal architectural design model 135 can be created for an n-tiered implementation. Therefore, the architectural design model 135 can be a trio of design models with one model representing the service layer, one model representing the controller layer, and one model representing the entity management layer.

It should be appreciated that conventional processes for generating an optimal information service architectural design model 135 are manual and rely upon the skill and experience of the solution architect 105 when deciding the applicability and application order of the patterns 132. The generation tool 115 of the current invention reduces the potential for inconsistent decisions that can be made by solution architects 105 with varying levels of skill and/or experience with generating architectural design models 135 for information services. This is of particular importance since service non-functional requirements 108 can be of a contradictory nature.

Further, use of a generation tool 115 can decrease the amount of time necessary to generate the optimal architectural design models 135, which can result in increased productivity.

As used herein, presented data stores, including store 130 can be a physical or virtual storage space configured to store digital information. Data store 130 can be physically implemented within any type of hardware including, but not limited to, a magnetic disk, an optical disk, a semiconductor memory, a digitally encoded plastic memory, a holographic memory, or any other recording medium. Data store 130 can be a stand-alone storage unit as well as a storage unit formed from a plurality of physical devices. Additionally, information can be stored within data store 130 in a variety of manners. For example, information can be stored within a database structure or can be stored within one or more files of a file storage system, where each file may or may not be indexed for information searching purposes. Further, data store 130 can utilize one or more encryption mechanisms to protect stored information from unauthorized access.

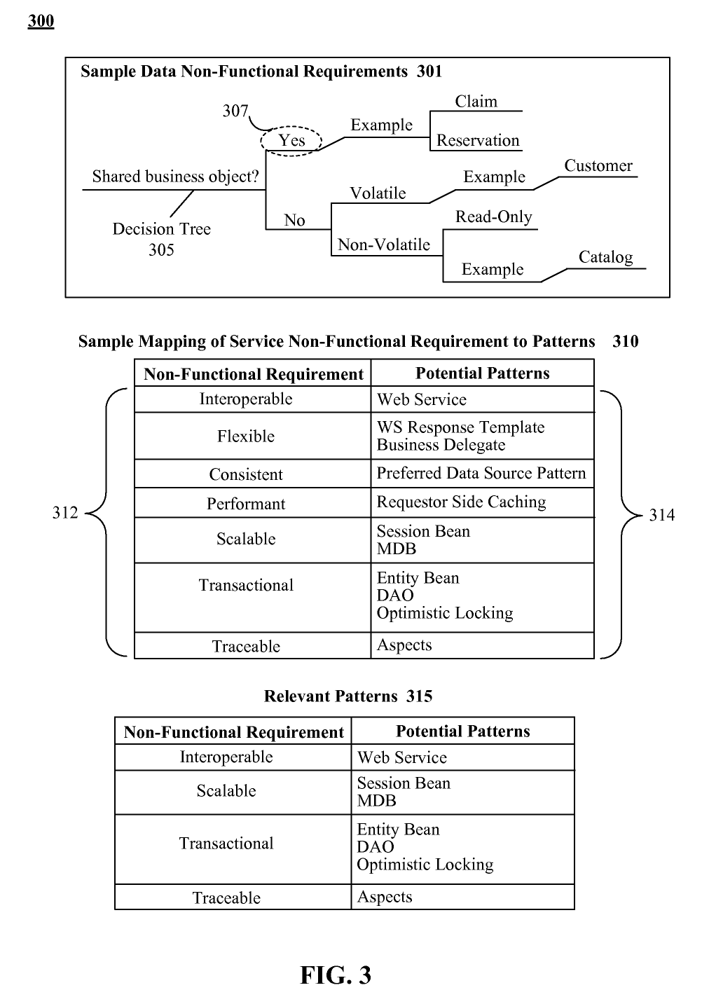

FIG. 2 is a sample data model 200 for an information service in accordance with an embodiment of the inventive arrangements disclosed herein. The sample data model 200 can be a used by system 100 or any other system that automates the generation of optimal architectural design models for information services. It should be noted that the sample data model 200 is for illustrative purposes only and is not meant as a definitive representation of implementation.

The sample data model 200 can be written in a formal modeling language, such as the Unified Modeling Language (UML) used in this example. In this example, the data model 200 is a UML class diagram for a catalog information service. The data model 200 can consist of five classes: catalog 205, CatalogItem 215, FeatureValue 225, Feature 230, and Money 240.

Each class 205, 215, 225, 235, and 240 can include a set of data attributes, such as set 207 belonging to the Catalog class 205. As shown in this example, the set of attributes 207 can include name, description, start date, and end date.

The arrows 210, 220, and 230 connecting the various classes 205, 215, 225, and 235 can imply a specific relationship (association) and cardinality between the classes being connected. The data model 200 in this example can be read as follows.

The Catalog class 205 can be related to the CatalogItem class 215 by arrow 210. Arrow 210 can represent an aggregation relationship, indicated by the hollow diamond, between the Catalog 205 and CatalogItems 215. That is, the Catalog 205 has CatalogItems 215, but CatalogItems instances can live independently of (are not contained by) a Catalog instance.

Further, arrow 210 can include cardinality values. In this example, the cardinality values of arrow 210 denote that a single Catalog 205 can be an aggregate of many CatalogItems 215, which is denoted by the asterisk.

The CatalogItems class 215 can be related to the FeatureValue class 225 via arrow 220. Arrow 220 can represent a composition relationship, indicated by the filled diamond, between the CatalogItems class 215 and FeatureValue class 225. A composition relationship is a stronger relationship than an aggregation; akin to saying that FeatureValues 225 instances can not exist independently of a CatalogItem 215 instance; a FeatureValue 225 instance is always contained by a CatalogItem 215 instance. Cardinality indicates that one CatalogItem 215 can have zero to many FeatureValues 225, and that there must be exactly one CatalogItem 215 for a given FeatureValue 225.

According to arrow 230, one FeatureValue 225 must have exactly one Feature 235, and vice versa.

The Money class 240 can represent a data type definition that can be used by other classes. In this example, the attribute 217, listPrice, of the CatalogItem class 215 references the Money class 240.

FIG. 3 is an example 300 illustrating the influence of non-functional requirements on pattern relevance in accordance with an embodiment of the inventive arrangements disclosed herein. The items 301 and 310 shown in example 300 can correspond to elements used by the generation tool 115 of system 100.

Example 300 can include a set of sample data non-functional requirements 301 and sample mapping of service non-functional requirements to patterns 310. The sample data non-functional requirements 301 can be represented in a multitude of formats, such as the decision tree 305 of the example 300. As shown, the decision tree 305 can outline key factors about the data portion of the information service.

The sample mapping 310 can relate service non-functional requirements 312 to applicable patterns 314. The mapping 310 can be of a format usable by the generation tool. In this example 300, the mapping 310 is formatted as a table with each row pertaining to a specific service non-functional requirement.

The data non-functional requirements 301 can influence the applicability of patterns in the mapping 310. An answer of “Yes” 307 to the main question, “Shared business object?” of the decision tree 305 can indicate the use of entity Enterprise Java Beans (EJB) in the information service. Since an entity EJB can degrade performance, it can imply that performant patterns are of little relevance to this information service. This is an example of the type of in-depth knowledge required when manually deciding the applicability of patterns.

Use of a generation tool can aggregate such knowledge and quickly determine a set of relevant patterns 315, based on the input that the data is a shared business object. The table of relevant patterns 315 can then be further processed with additional information regarding the non-functional requirements of the information service.

As mentioned above, shared business objects degrade performance, thus, the tool can remove any patterns for the performant non-functional requirement. Further, because the tool “knows” that shared business objects are not cacheable, it can remove patterns associated with performance. An inexperienced solution architect can easily overlook or not understand these in-depth relationships between non-functional requirements and pattern applicability.

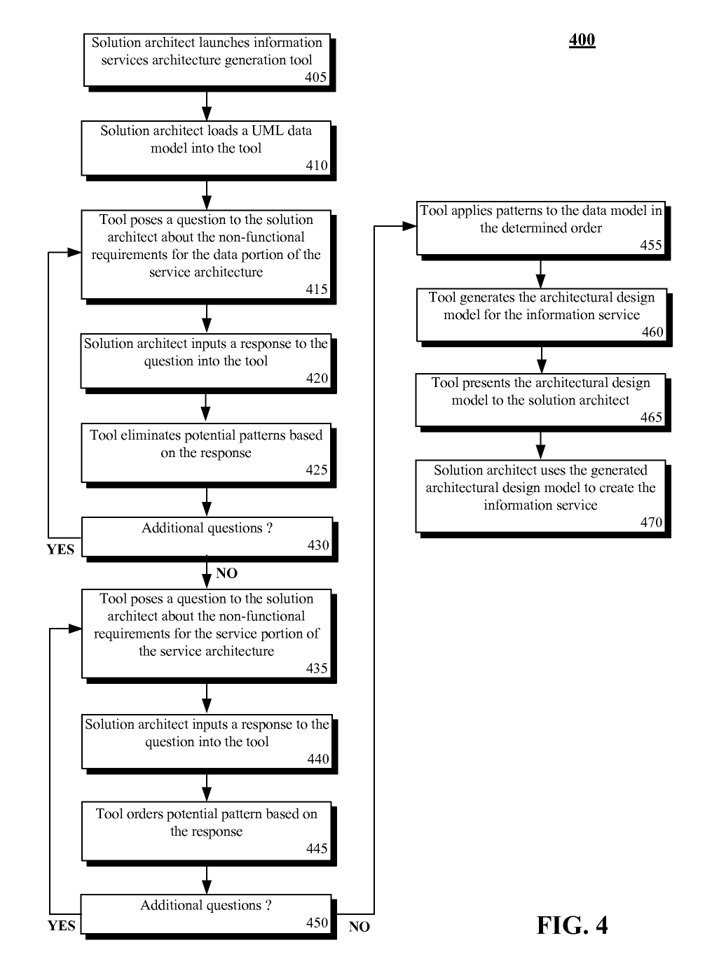

FIG. 4 is a flow chart of a method 400 for using an automated solution to generate optimal architectural design models for information services in accordance with an embodiment of the inventive arrangements disclosed herein. Method 400 can be performed within the context of system 100 and/or using the sample data model 200 of FIG. 2, or any other system configured to automate the generation of optimal architectural design models.

Method 400 can begin with step 405 where a solution architect launches an information services architecture generation tool. The solution architect can load a UML data model into the generation tool in step 410.

In step 415, the generation tool can pose a question to the solution architect pertaining to the data non-functional requirements of the information service. The solution architect can input a response to the question in step 420. In step 425, the generation tool can eliminate potential patterns from a set of available patterns.

In step 430, the generation tool can determine if the additional questions need input. If so, flow can return to step 415, repeating steps 415 through step 430 until all questions have been asked and answered. Once all questions are answered, step 435 can execute in which the generation tool can pose a question to the solution architect regarding the service non-functional requirements of the information service.

In step 440, the solution architect can input a response to the question in step 440. The generation tool can order the potential patterns in step 445. In step 450, the generation tool can determine if the additional questions need input.

When additional questions remain, flow can return to step 435, repeating steps 435 through step 450 until all questions have been asked and answered. Once all questions are answered, step 455 can execute in which the generation tool can apply the patterns to the data model loaded in step 410 in the determined order.

In step 460, the generation tool can generate the architectural design model for the information service. This architectural design model can be presented to the solution architect in step 465. In step 470, the solution architect can use the generated architectural design model to create the information service.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A system for automating the creation of architectural design models for information services comprising:
a data model describing an information service, wherein the data model is written in a formal modeling language;
a set of non-functional requirements for the information service architecture, wherein the set includes data and service non-functional requirements; and
an information service architecture generation tool configured to utilize the data model and one or more elements from the set of non-functional requirements to create an architectural design model for the information service for implementation in a service-oriented architecture (SOA) environment, wherein the creation of the architectural design model is based upon a consistent application of SOA patterns.

2. The system of claim 1, wherein the generation tool interfaces with a commercially-available model-driven software development tool, wherein the generation tool has access to a plurality of assets associated with the software development tool.

3. The system of claim 2, wherein the plurality of assets includes a pattern engine and a transformation framework.

4. The system of claim 2, wherein the commercially-available software development tool is a version of IBM RATIONAL SOFTWARE ARCHITECT (RSA).

5. The system of claim 1, wherein the information service architecture generation tool further comprises:
a set of application patterns, wherein each pattern corresponds to a specific service non-functional requirement;
a user interface configured to collect user-input data about the set of non-functional requirements; and
a pattern determination engine configured to utilize the user-input data collected by the user interface to determine a relevance and an order of application for the set of patterns upon the data model.

6. The system of claim 5, wherein a collecting of user-input data by the user interface involves a display of a series of questions, wherein the user-input data represents a series of answers corresponding to the series of questions.

7. The system of claim 1, wherein the architectural design model is written in a formal modeling language, and wherein the design model is of a format suitable for transformation into a lower-level abstraction.

8. The system of claim 1, wherein the architectural design model is comprised of a set of models for a n-tiered service implementation, wherein said set includes models for a service layer, a controller layer, and an entity management layer.

9. The system of claim 1, wherein the data model is a represented in the Unified Modeling Language (UML).

10. An automated method for generating architectural design models for information services in a service-oriented architecture (SOA) environment comprising:
launching an information service architecture generation tool;
loading into said tool a data model, wherein the data model describes an information service to be implemented within a service-oriented architecture (SOA) environment;
the generation tool soliciting data pertaining to a plurality of non-functional requirements for the information service;
inputting data into a user interface of the generation tool in response to the soliciting step; and
the generation tool automatically synthesizing an optimal architectural design model for the information service, wherein the synthesizing step utilizes a set of known SOA application patterns, wherein each application pattern corresponds to a service non-functional requirement.

11. The method of claim 10, wherein the soliciting and inputting steps are repeated until the generation tool reaches a termination condition, wherein the attainment of the termination condition results in an execution of the synthesizing step.

12. The method of claim 10, wherein the data model and optimal architectural design model are written in a formal modeling language.

13. The method of claim 10, wherein during the synthesizing step, the generation tool interfaces with a commercially-available model-driven software development tool, wherein the generation tool has access to a plurality of assets associated with the software development tool.

14. The method of claim 10, further comprising:
optionally disqualifying a use of one or more application patterns from the set of known patterns to be used in the synthesizing step based on the data entered in the inputting step.

15. The method of claim 10, wherein the optimal architectural design model is comprised of a set of models for a n-tiered service implementation, wherein said set includes models for a service layer, a controller layer, and an entity management layer.

16. The method of claim 10, wherein said steps of claim 10 are performed by at least one machine in accordance with at least one computer program stored in a computer readable media, said computer programming having a plurality of code sections that are executable by the at least one machine.

17. An information service architecture generation tool comprising:
a set of application patterns, wherein each pattern corresponds to a specific service non-functional requirement;
a user interface configured to collect user-input data regarding non-functional requirements of an information service, wherein the information service is to be implemented within a service-oriented architecture (SOA) environment; and
a pattern determination engine configured to utilize the user-input data collected by the user interface to determine a relevance and an order of application for the set of patterns upon a data model representing the information service to produce an architectural design model for the information service.

18. The generation tool of claim 17, wherein said components interface with a commercially-available model-driven software development tool, wherein the components have access to a plurality of assets associated with the software development tool.

19. The generation tool of claim 17, wherein the data model and architectural design model are written in a formal modeling language.

20. The generation tool of claim 17, wherein the architectural design model is comprised of a set of models for a n-tiered service implementation, wherein said set includes models for a service layer, a controller layer, and an entity management layer.
